(19) United States
(12) Patent Application Publication
(10) Pub. No.: US 2010/0123049 A1
(43) Pub. Date: May 20, 2010

(54) Medical gas hose support system

(76) Inventors: Vincent M. Lehman, Barberton, OH (US); Jaeson L. Stafford, Barberton, OH (US); Joseph (NMI) Pilz, JR., North Canton, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/313,303

(22) Filed: Nov. 20, 2008

(51) Int. Cl. F16L 3/08; A47B 96/06

(52) U.S. Cl. 248/70; 248/220.21

(57) ABSTRACT

An medical gas hose support system for operating room use includes a clevis mounted to an operating room wall and pivotally receiving a first hollow arm. A second hollow arm is connected through a pivotal connection to the first hollow arm. The pivotal connector allows for pivotal relationship between the two arms while maintaining a clearance therebetween. An array of medical gas hoses and other conductors pass through the hollow arms and pivotal connector. The medical gas hose support system allows for the support of medical gas hoses and the like in an appropriate manner for their use within a room and storage thereof when not in use, all the while keeping the array of medical gas hoses and conductors from providing obstacles to movement of personnel and equipment within the surgical operating room.

### TECHNICAL FIELD

The invention herein resides in the art of medical apparatus and, more particularly, to such apparatus as employed in various settings within medical centers. Specifically, the invention relates to a medical gas hose support system for use in operating rooms, and in which the medical gas hoses are readily available for accessability by medical professionals, but are not intrusive or otherwise cause obstacles to movement within the medical facility.

### BACKGROUND OF THE INVENTION

The use of medical gas within medical facilities is commonplace and well known. Typically, various medical gas outlets are provided in the wall or ceiling of a room and connection is made to these outlets with medical gas hoses which are then necessarily taken to the apparatus or machine utilizing them for administration to the patient. In the past, these medical gas hoses have either simply passed over the floor of the operating room, where they are taped in place, or they have been hung from the ceiling of the room by the use of various supports and connectors. Both are insecure and given to accident. Medical gas hoses on the floor provide an obstacle for walking about the operating room and can give rise to tripping or stumbling. In addition, they inhibit the motion of items of equipment within the room that have cause to move throughout the space. Similarly, hoses hung from the ceiling of the room cause obstruction within the room and offer potentials for injury to those within the space. The current alternative to these methods of medical gas hose support is both costly and cumbersome to the room operation. It also results in obstruction to movement of the room occupants.

### DISCLOSURE OF INVENTION

In light of the foregoing, it is a first aspect of the invention to provide a medical gas hose support system in which the medical gas hoses are securely maintained and out of the path of room personnel.

Another aspect of the invention is the provision of a medical gas hose support system in which the medical gas hoses are readily accessible for movement to and from the necessary equipment and for uses required by the room staff.

Another aspect of the invention is the provision of a medical gas hose support system in which the system and accompanying medical gas hoses can be stored and deployed quickly, easily, and reliably, as needed.

Yet a further aspect of the invention is the provision of a medical gas hose support system that may be readily constructed using state of the art devices and techniques, and which can be readily adapted for implementation in virtually any medical facility.

The foregoing and other aspects of the invention that will become apparent as the detailed description proceeds are achieved by a medical gas hose support system for operating room use, comprising: a bracket assembly adapted for mounting to a wall of an operating room; a first arm having a first end thereof pivotally connected to said bracket; a second arm having a first end thereof pivotally connected to a second end of said first arm; and medical gas hoses maintained by said first and second arms and extending therealong.

Other aspects of the invention that will become apparent herein are achieved by a medical gas hose support system for operating room use, comprising: a wall-mounted bracket assembly; a first hollow arm having first and second ends, said first end being pivotally connected to said bracket assembly; a second hollow arm having first and second ends, said first end of said second arm being pivotally connected to said second end of said first arm; medical gas hoses passing from said bracket assembly and through said first and second hollow arms and out of said second end of said second arm; and wherein said first and second arms are pivotally interconnected through a connector comprising a pair of contacting cams, maintaining a clearance at said interconnection for passage of said medical gas hoses.

### BRIEF DESCRIPTION OF DRAWINGS

For a complete understanding of the various aspects, structures and techniques of the invention, reference should be made to the following detailed description and accompanying drawings wherein:

FIG. 1 is a pictorial illustration of the medical gas hose support system of the invention shown in a posture of partial extension;

FIG. 2 is a pictorial illustration of the medical gas hose support system of the invention shown in a stored position;

FIG. 3 is a pictorial illustration of the medical gas hose support system of the invention showing full extension and hose support thereof;

FIG. 4 is a top plan view of the bracket assembly and its interconnection with a first arm of the medical gas hose support system of the invention;

FIG. 5 is an illustration of an end of the second arm of the medical gas hose support system of the invention along with the hose clamping system to prevent undue stresses on the wall or ceiling gas outlets, showing the medical gas hoses extending therefrom;

FIG. 6 is a pictorial illustration of the spacer, cam and gear assembly employed for interconnecting the first and second arms of the medical gas hose support system of the invention, while preventing kinking or pinching of the medical gas hoses;

FIG. 7 is a partial sectional view of a first arm of the medical gas hose support system of the invention showing connecting flanges at the end thereof;

FIG. 8 is an illustration of the wall plate clevis connector of the invention; and

FIG. 9 is a front perspective view of the pin employed for interconnection between the flanges of FIG. 7 and the clevis connector of FIG. 8.

### BEST MODE FOR CARRYING OUT THE INVENTION

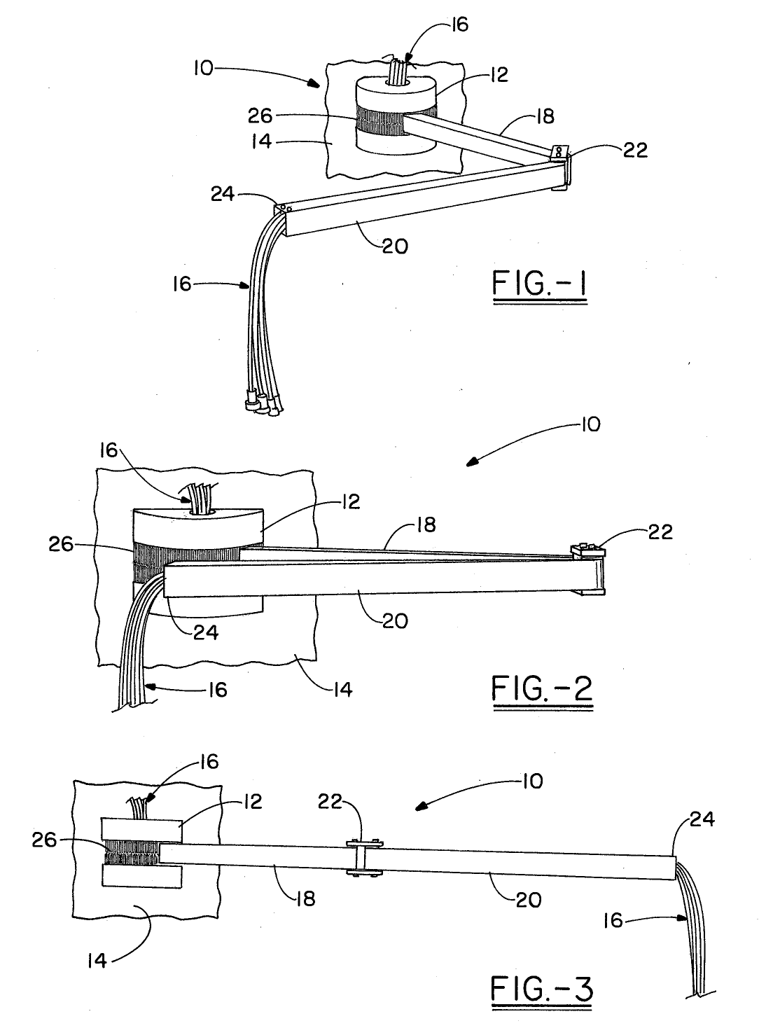

Referring now to the drawings and more particularly to FIGS. 1-3, it can be seen that a medical gas hose support system made in accordance with the invention is designated generally by the numeral 10. The system 10 comprises a cover 12 fixed in relation to the wall of a room 14. An array of medical gas hoses 16 passes from the cover 12 for appropriate interconnection to either wall or ceiling mounted outlets (not shown) on the wall 14 or ceiling of the room. Typically, the hoses are for various types of medical gases, while the invention further contemplates that the array 16 may also include electrical conductors and the like.

The assembly 10 includes a first arm member 18 pivotally connected to a second arm member 20 through a pivotal connection plate or bracket 22. The arm members 18, 20 are preferably hollow tube members, having a hollow interior defining a passage therethrough. The array of tubes 16 passes through this passage within the arms 18, 20 and through the pivotal connection assembly 22, with the array 16 exiting the arm 20 at the end 24 thereof.

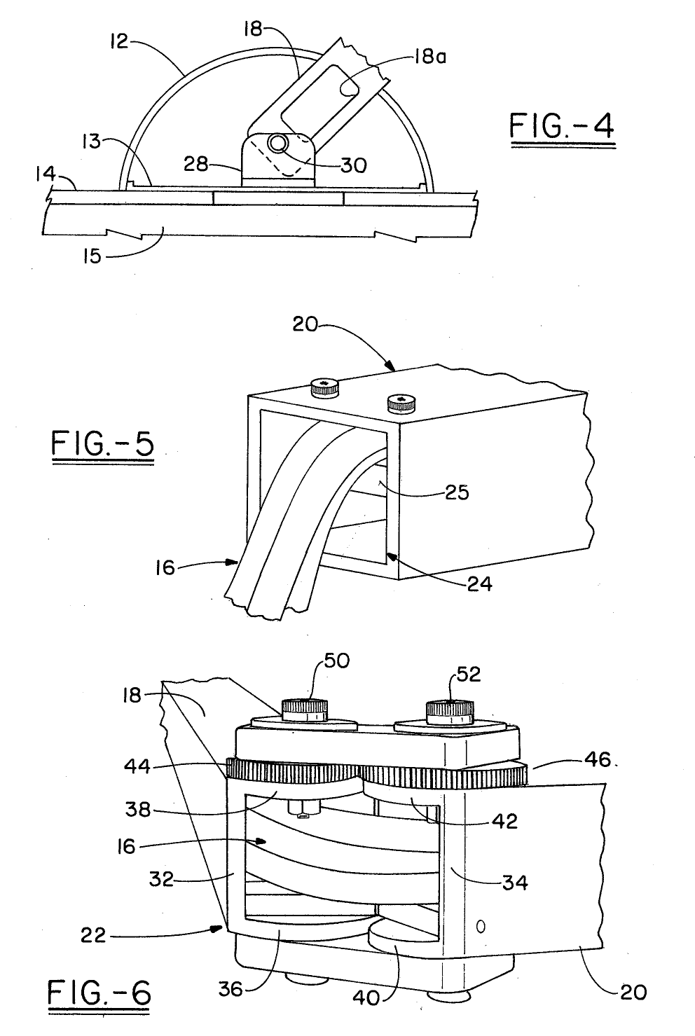

As shown in FIGS. 1-3, which illustrate various positions of the arms 18, 20, it can be seen that the cover 12 consists of upper and lower semi-cylindrical cover members providing an opening or slot therebetween through which the arm 18 may pivotally pass. This slot is covered by a curtain or seal 26 which, in a preferred embodiment of the invention, is a bristle seal comprising downwardly extending bristles from the upper portion of the cover 12, and upwardly extending bristles extending from the lower portion thereof. This curtain or seal serves to conceal and protect the pivotal interconnection of the arm 18 to the wall 14 and provides a barrier to dust and dirt accumulation within the enclosure, as best shown in FIG. 4.

As shown in FIG. 4, a clevis bracket wall plate assembly 28 is secured to the operating room wall 14 as by attachment to wooden support plates 15 secured between wall studs (not shown) and is provided with a pivot pin 30 that passes through upper and lower end flanges of the arm 18 at a first end thereof. The cover 12 is attached to a cover bracket 13, which is secured to the clevis bracket 28. The end of the arm 18 has an aperture 18a in a top wall thereof to receive passage of the array 16 of hoses and conductors into the internal passage of the arms 18, 20. The opposite end of the interconnected arm assembly 18, 20 is shown in FIG. 5, where the end 24 of the arm 20 is shown as being hollow and from which the array of hoses and conductors 16 passes, while being held in place by hose clamp 25. The clamp 25 prevents undue stress from being placed on the wall or ceiling connections of the medical gas hoses, thereby eliminating the potential for stress-induced connection failures.

As presented above, a first end of the arm 18 is pivotally connected to a clevis bracket wall plate assembly 28 by a pin 30. The second end of the arm 18 is connected to a first end of the arm 20 through a pivotal connection bracket 22, thus shown in FIG. 6. As illustrated in FIG. 6, cylindrical cams 32, 34 are provided at respective ends of the arms 18, 20, and are defined by substantially semicircular cam disk portions 36, 38, 40, 42 as illustrated. These semicircular cam disks are in contacting engagement with each other during relative pivotal movement between the arms 18, 20 to ensure that necessary spacing is maintained therebetween during such articulation of the arms 18, 20 in order to ensure a clearance is achieved for passage of the array of hoses and conductors 16. As illustrated, the cylindrical cams 32, 34, having the upper and lower cam disks 36-42 thereon, may be formed as integral portions of the respective arms 18, 20.

Pinion gears 44, 46 respectively associated with the arms 18, 20 are also provided in intermeshing engagement with each other. The pinion gears provide rigidity and stability to the interconnection of the arms 18, 20 as they pivot with respect to each other. Further, the pinion gears 44, 46 provide some resistance to such pivoting, such that the arms 18, 20 are not given to inadvertent movement or rotational displacement with respect to each other, but are responsive to the application of an intentional force applied for purposes of achieving such movement. As shown, nut and bolt assemblies 50, 52 are provided at the top and bottom of the pivotal connector 22 to secure the respective cylindrical cams 32, 34 and pinion gears 44, 46 to the associated arm 18, 20 as shown.

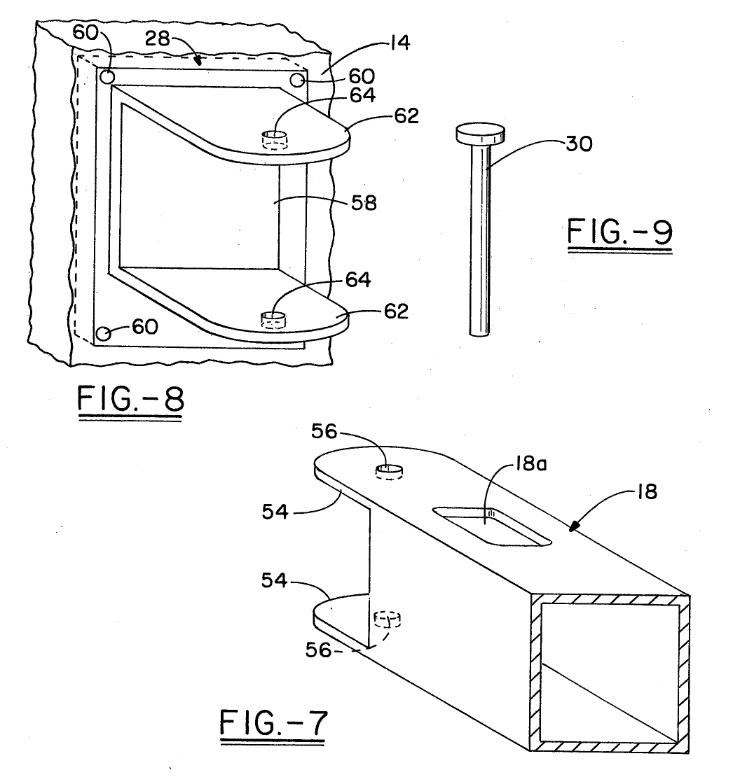

With reference now to FIGS. 7-9, the structure required for mounting the medical gas hose support system 10 to a room wall 14 can be appreciated. As shown, flanges 54 extend from top and bottom edges of the arm 18 and are provided with apertures or holes 56 passing therethrough. A wall plate assembly 28 is secured to the wall 14 as by attachment to wooden plates 15 (FIG. 4) by means of appropriate lag screws 60 or nut and bolt assemblies. The wall plate assembly 28 includes mounting bracket 58 and clevis brackets 62 with aligned holes 64 passing therethrough. This clevis bracket wall plate assembly 28 is thus adapted to receive the end of the arm 18, with the holes 56 of the flanges 54 aligned with the holes 64 of the clevis brackets 62 such that the arm 18 may be secured to the clevis bracket wall plate assembly 28 by means of the pivot pin 30.

Those skilled in the arm will appreciate that the assembly just described allows for pivotal movement of the first arm 18 throughout an arc of approximately 180°. Similarly, the pivotal connector 22 allows for substantially full circular movement of the arm 20 with respect to the arm 18, without binding or pinching the array of medical gas hoses and conductors 16 during such movement. As a consequence, the medical gas hose support system 10 can be substantially stored along the wall 14 of the room, or deployed to any of a range of various desirable orientations and positions, as illustrated in FIGS. 1-3. During such movement, the medical gas hoses and other conductors are unobtrusive and pose no obstacle to full utility of the room.

Thus it can be seen that the various aspects of the invention have been achieved by the structure presented and described above. While in accordance with the patent statutes only the best mode and preferred embodiment of the invention has been presented and described in detail, the invention is not limited thereto or thereby. Accordingly, for an appreciation of the true scope and breadth of the invention reference should be made to the following claims.

What is claimed is:

1. An medical gas hose support system for operating room use, comprising:
a bracket assembly adapted for mounting to a wall of an operating room;
a first arm having a first end thereof pivotally connected to said bracket;
a second arm having a first end thereof pivotally connected to a second end of said first arm; and
medical gas hoses maintained by said first and second arms and extending therealong.

2. The medical gas hose support system for operating room use as recited in claim 1, wherein said first and second arms pivotally interconnect through rotatable contacting members.

3. The medical gas hose support system for operating room use as recited in claim 2, wherein said rotatable contacting members comprise intermeshing pinion gears.

4. The medical gas hose support system for operating rooms as recited in claim 3, wherein said rotatable contacting member further comprise contacting cam surfaces.

5. The medical gas hose support system for operating rooms as recited in claim 2, wherein said arms have hollow passages therethrough, said hollow passages receiving and maintaining said medical gas hoses.

6. The medical gas hose support system for operating rooms as recited in claim 5, wherein said rotatable contacting members maintain a clearance through which said medical gas hoses pass throughout articulation of said first and second arms with respect to each other.

7. The medical gas hose support system for operating rooms as recited in claim 6, further comprising a shroud covering said bracket, said shroud having an opening therein accommodating rotational movement of said first arm.

8. The medical gas hose support system for operating rooms as recited in claim 7, further comprising a moveable curtain covering said opening.

9. The medical gas hose support system for operating rooms as recited in claim 8, wherein said curtain comprises an array of upwardly and downwardly extending bristles.

10. The medical gas hose support system for operating rooms as recited in claim 9, wherein said bracket comprises a clevis bracket and pin engaging extension flanges of said first arm.

11. An medical gas hose support system for operating room use, comprising:
a wall-mounted bracket assembly;
a first hollow arm having first and second ends, said first end being pivotally connected to said bracket assembly;
a second hollow arm having first and second ends, said first end of said second arm being pivotally connected to said second end of said first arm;
medical gas hoses passing from said bracket assembly and through said first and second hollow arms and out of said second end of said second arm; and
wherein said first and second arms are pivotally interconnected through a connector comprising a pair of contacting cams, maintaining a clearance at said interconnection for passage of said medical gas hoses.

12. The medical gas hose support system for operating room use as recited in claim 11, wherein said connector further comprises a pair of intermeshing gears, one gear connected to each of said first and second arms.

13. The medical gas hose support system for operating room use as recited in claim 12, wherein said intermeshing gears provide a resistance to relative pivotal movement between said first and second arms.

14. The medical gas hose support system for operating room use as recited in claim 13, wherein said contacting cams are semicircular.

15. The medical gas hose support system for operating room use as recited in claim 11, wherein said bracket assembly comprises a clevis and pin receiving said first arm within a housing having a slot therein for pivotal movement of said first arm about said pin, and further comprising a curtain closing said slot about said first arm.
